(19) United States
(12) Patent Application Publication
(10) Pub. No.: US 2024/0072436 A1
(43) Pub. Date: Feb. 29, 2024

(54) ADDITIVELY MANUFACTURED INTERNALLY METALIZED ANTENNA ARRAY APERTURE

(71) Applicant: The MITRE Corporation, McLean, VA (US)

(72) Inventors: Eric Douglas ROBINSON, Asheville, NC (US); Laura Marie AUDINO, Ellicott City, MD (US); Francisco RAMOS-CARRIZOSA, Roseville, MN (US); Sean Michael FLANAGAN, North Andover, MA (US)

(73) Assignee: The MITRE Corporation, McLean, VA (US)

(21) Appl. No.: 18/452,221

(22) Filed: Aug. 18, 2023

Related U.S. Application Data
(60) Provisional application No. 63/402,782, filed on Aug. 31, 2022.

(51) Int. Cl. H01Q 3/34; B33Y 80/00

(52) U.S. Cl. CPC H01Q 3/34; B33Y 80/00

(57) ABSTRACT

Provided herein is a unit cell for a phased array antenna. The unit cell can include a base plate and a shell. The shell can include a plurality of spectrum element cavities, with each spectrum element cavity comprising a post. An inner surface of each of the spectrum element cavities can be coated with a conductive material such that the spectrum element cavities form a signal ear and a ground ear of the unit cell. The base plate can be configured to provide a path to ground and include a plurality of holes. The shell can be aligned with the base plate such that the post of each signal ear of each spectrum element cavity is aligned with one of the holes of the base plate.

### CROSS REFERENCE TO RELATED APPLICATION

This application claims the benefit of U.S. Provisional Application No. 63/402,782, filed Aug. 31, 2022, the entire contents of which is incorporated herein by reference.

### FIELD OF THE DISCLOSURE

This disclosure relates generally to antennas, and more specifically to internally metallized additively-manufactured apertures for phased array antennas.

### BACKGROUND OF THE DISCLOSURE

Wide-band phased array antennas can be used in various applications, such as satellite communications (SATCOM), radar, remote sensing, direction finding, etc. Tightly-coupled phased arrays are a versatile array architecture that provides ultra-wide bandwidth (more than one octave bandwidth) performance with wide-scanning capability. A tightly-coupled phased array is an array of antenna elements that are capable of collectively forming a beam using the respective signals received by each of the antenna elements.

One type of tightly-coupled array antenna is an aperture array, which includes an array of apertures (e.g., openings) through which energy can be emitted or received. In one exemplary array, individual apertures can be formed from a pair of arms (or “ears”) separated by a gap, however other geometries are also possible. The arms of the individual apertures can be formed from a metallic material or otherwise coated in a metallic material such that the arms can act as radiators. An aperture array can include a base plate with an array of individual apertures extending upwards from the base plate.

The apertures of an aperture array can be manufactured using various manufacturing processes. For instance, antenna apertures can be manufactured via computer numerical control (CNC) machining and metal additive manufacturing. However, several design challenges exist when fabricating apertures and aperture arrays via the various manufacturing processes described above. For example, when using additive manufacturing to manufacture one type of aperture array, it can be necessary to include a support leg on the positive dipole arm (also called an “ear”) in order to print the aperture array in place on a single base plate. Moreover, a substantial number of parts of the aperture array may require some post-processing to improve surface finish. When manufacturing on a large scale, the required post-processing can be a bottleneck that hinders or lengthens the production time of the aperture array. For interior parts of the array, post-processing may not be possible at all.

Aperture arrays may also require a connector interface that facilitates the connection between the additively manufactured elements of the aperture array and a coaxial connector or a printed circuit board. While built-in connector designs may be possible, sometimes an extra layer of RF interposer such as “Fuzz-Buttons™” is necessary for this connection. Adding an extra element to the array can increase the cost, effort, and time necessary to assemble the aperture array. Finally, although an entirely metallic aperture array can be manufactured via metal additive manufacturing, an entirely metallic aperture array may be heavy and costly and can require an air-gap between the ears of the metallic aperture elements, which can restrict the maximum coupling capacitance between aperture elements and thus limit bandwidth of the array.

### SUMMARY OF THE DISCLOSURE

Accordingly, provided herein is an internally metallized aperture element for use in a phased aperture antenna array. In one or more examples, the aperture element can include a single continuous shell of polymer that is additively manufactured using a polymeric material. In one or more examples, the shell can include internal cavities that extend between an open top and bottom surface of the block, and the internal surfaces of these cavities can be metalized via a metallization process. A phased aperture array manufactured according to the additive manufacturing and metallization processes disclosed herein can have an overall geometry that is inverted relative to an aperture array manufactured via the other manufacturing processes described above. Although the geometry can be inverted relative to an aperture array manufactured via the other manufacturing processes described above, the aperture array fabricated as disclosed herein can include an internally metallized polymeric shell that forms a radiating element surface in the same shape of the array elements manufactured using the above processes. Beneficially, manufacturing the aperture array as disclosed herein with a continuous metallized polymeric shell is more structurally robust and realizes significant fabrication cost and time savings. Moreover, by relying on a continuous polymeric shell for the structure of the array, the aperture array can incorporate a structure made of a dielectric material between radiating elements of each aperture, which provides stronger capacitive coupling and improves the performance of the array relative to aperture arrays with an air gap between the radiating elements.

In one or more examples, a unit cell for a phased array antenna, comprises: a base plate, wherein the base plate is configured to provide a path to ground, and wherein the base plate comprises a plurality of holes, a shell that comprises a plurality of spectrum element cavities, wherein an inner surface of each of the spectrum element cavities is coated with a conductive material to form a signal ear and a ground ear that each comprise a post, and wherein the shell is aligned with the base plate such that the post of the signal ear of each spectrum element cavity is aligned with one of plurality of holes of the base plate.

Optionally, the shell is formed using an additive manufacturing process.

Optionally, the shell is formed from a dielectric material.

Optionally, the additive manufacturing process includes stereolithography.

Optionally, the additive manufacturing process includes VAT polymerization.

Optionally, the inner surfaces of each spectrum element cavity are coated with a copper layer.

Optionally, the copper layer is 0.002 inches thick.

Optionally, the base plate comprises a plurality of mating protrusions.

Optionally, the shell is aligned with the base plate such that the post of the ground ear of each spectrum element cavity is aligned with one of the plurality of mating protrusions of the base plate.

Optionally, the base plate is formed from aluminum.

Optionally, two adjacent spectrum element cavities of the plurality of spectrum element cavities are arranged orthogonally relative to one another.

Optionally, the signal ear of a first spectrum element cavity is located proximate to the signal ear of an adjacent spectrum element cavity separated by a gap.

Optionally, the unit cell comprises a superstrate located on a top surface of the shell, the superstrate comprising an internal cavity that is aligned with the gap between the signal ears of each spectrum element cavity of the shell.

Optionally, the superstrate is formed from PTFE.

Optionally, an inner surface of each of the signal ears and the ground ears of the spectrum element cavities comprises a taper.

Optionally, the post of each of the signal ears is connected to a connector.

Optionally, the connection between each signal ear and each connector provides an electrically isolated path.

In one or more examples, a phased array antenna comprises: a plurality of unit cells, wherein each unit cell comprises: a base plate, wherein the base plate is configured to provide a path to ground, and wherein the base plate comprises a plurality of holes, a shell that comprises a plurality of spectrum element cavities, wherein an inner surface of each of the spectrum element cavities is coated with a conductive material to form a signal ear and a ground ear that each comprise a post, and wherein the shell is aligned with the base plate such that the post of the signal ear of each spectrum element cavity is aligned with one of plurality of holes of the base plate.

Optionally, the shell is formed using an additive manufacturing process.

Optionally, the shell is formed from a dielectric material.

Optionally, the additive manufacturing process includes stereolithography.

Optionally, the additive manufacturing process includes VAT polymerization.

Optionally, the inner surfaces of each spectrum element cavity are coated with a copper layer.

Optionally, the copper layer is 0.002 inches thick.

Optionally, the base plate comprises a plurality of mating protrusions.

Optionally, the shell is aligned with the base plate such that the post of the ground ear of each spectrum element cavity is aligned with one of the plurality of mating protrusions of the base plate.

Optionally, the base plate is formed from aluminum.

Optionally, two adjacent spectrum element cavities of the plurality of spectrum element cavities are arranged orthogonally relative to one another.

Optionally, the signal ear of a first spectrum element cavity is located proximate to the signal ear of an adjacent spectrum element cavity separated by a gap.

Optionally, the unit cell comprises a superstrate located on a top surface of the shell, the superstrate comprising an internal cavity that is aligned with the gap between the signal ears of each spectrum element cavity of the shell.

Optionally, the superstrate is formed from PTFE.

Optionally, an inner surface of each of the signal ears and the ground ears of the spectrum element cavities comprises a taper.

Optionally, the post of each of the signal ears is connected to a connector.

Optionally, the connection between each signal ear and each connector provides an electrically isolated path.

In one or more examples, a method for manufacturing a unit cell for a phased array antenna, the method comprises: adding a material in an additive manner to form a shell, wherein the shell comprises a plurality of spectrum element cavities, metallizing an inner surface of each of the spectrum element cavities with a conductive material to form a signal ear and a ground ear that each comprise a post, and connecting the shell to a base plate that comprises a plurality of holes, wherein the base plate is configured to provide a path to ground, wherein the shell is aligned with the base plate such that the post of the signal ear of each spectrum element cavity is aligned with one of the plurality of holes of the base plate.

Optionally, the material of the shell is a dielectric material.

Optionally, adding the material in the additive manner comprises employing a stereolithography process.

Optionally, adding the material in the additive manner comprises employing a VAT polymerization process.

Optionally, metallizing the inner surface of each spectrum element cavity comprises: masking an outer surface of each spectrum element cavity to prevent metallization, and electroplating the inner surface of each spectrum element cavity via an electroplating bath.

Optionally, the inner surface of each spectrum element is metallized with a copper layer.

Optionally, the copper layer is 0.002 inches thick.

Optionally, the base plate comprises a plurality of mating protrusions.

Optionally, the shell is aligned with the base plate such that the post of the ground ear of each spectrum element cavity is aligned with one of the plurality of mating protrusions of the base plate.

Optionally, the base plate is formed from aluminum.

Optionally, two adjacent spectrum element cavities of the plurality of spectrum element cavities are arranged orthogonally relative to one another.

Optionally, the signal ear of a first spectrum element is located proximate to the signal ear of an adjacent spectrum element cavity separated by a gap.

Optionally, the method comprises: connecting a superstrate to a top surface of the shell, the superstrate comprising an internal cavity, wherein the internal cavity of the superstrate is aligned with the gap between the signal ears of each spectrum element cavity of the shell.

Optionally, the superstrate is formed from PTFE.

Optionally, an inner surface of each of the signal ears and the ground ears of the spectrum element cavities comprises a taper.

Optionally, the post of each of the signal ears is connected to a connector.

Optionally, the connection between each signal ear and each connector provides an electrically isolated path.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE FIGURES

The invention will now be described, by way of example only, with reference to the accompanying drawings, in which:

FIG. 1 illustrates an exploded view of a unit cell for a phased array antenna, according to one or more examples of the present disclosure;

FIG. 2 illustrates a perspective view of a unit cell for a phased array antenna, according to one or more examples of the present disclosure;

FIG. 3 illustrates a side view of an internally metallized antenna array shell, according to one or more examples of the present disclosure;

FIG. 4A illustrates a side view of a unit cell for a phased array antenna, according to one or more examples of the present disclosure;

FIG. 4B illustrates an exploded side view of an exemplary connector region of a unit cell for a phased array antenna, according to one or more examples of the present disclosure;

FIG. 4C illustrates an assembled side view of the connector region of the unit cell of FIG. 4B, according to one or more examples of the present disclosure;

FIG. 5A illustrates a plan view of a phased array antenna, according to one or more examples of the present disclosure;

FIG. 5B illustrates a perspective view of a phased array antenna, according to one or more examples of the present disclosure;

FIG. 6 shows an exemplary process for manufacturing a unit cell for a phased array antenna, according to one or more examples of the present disclosure;

FIG. 7 shows an exemplary process for internally metallizing a shell for a phased array antenna, according to one or more examples of the present disclosure; and

FIG. 8 illustrates an exemplary computing device, in accordance with one or more examples of the disclosure.

### DETAILED DESCRIPTION OF THE DISCLOSURE

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

Reference is sometimes made herein to an array antenna having a particular array shape (e.g., a planar array). One of ordinary skill in the art would appreciate that the techniques described herein are applicable to various sizes and shapes of array antennas. It should thus be noted that although the description provided herein describes the concepts in the context of a rectangular array antenna, those of ordinary skill in the art would appreciate that the concepts equally apply to other sizes and shapes of array antennas as well as cylindrical, conical, spherical and arbitrary shaped conformal array antennas.

Reference is also made herein to an array antenna including radiating elements of a particular size and shape. For example, certain examples of radiating elements are described as having a shape and a size compatible with operation over a particular frequency range (e.g., 2-30 GHz). Those of ordinary skill in the art would recognize that other shapes of antenna elements may also be used and that the size of one or more radiating elements may be selected for operation over any frequency range in the RF frequency range (e.g., any frequency in the range from below 20 MHz to above 50 GHz).

Reference is sometimes made herein to generation of an antenna beam having a particular shape or beam-width. Those of ordinary skill in the art would appreciate that antenna beams having other shapes and widths may also be used and may be provided using known techniques such as by inclusion of amplitude and phase adjustment circuits into appropriate locations in an antenna feed circuit.

Described herein are examples of antenna apertures and phased aperture arrays. These phased aperture arrays can be formed of repeating cells of antenna apertures. The phased aperture arrays disclosed herein achieve an active VSWR (voltage standing wave ratio) of 3.2:1 or less over a 7.3:1 frequency bandwidth while scanning to 60° in the E, H, and D scan planes with high cross-polarization gain isolation over most of the band. The phased aperture arrays discussed herein can be configured as single polarized or dual polarized based on excitation of the array (e.g., based on which feed ports of the aperture array have a signal applied). Alternatively, the phased aperture arrays disclosed herein can be fabricated such that only one polarization is present.

A unit cell (e.g., an aperture element) of a phased aperture array can include a pattern of radiating elements located between a base plate and a superstrate. Unit cells can rely on entirely metal radiating elements. As discussed above, the radiating elements of a phased aperture array can be formed from metal elements fabricated via additive manufacturing. However, such arrays may rely on a support leg that limits performance and require post-processing that extends production.

In the phased aperture arrays disclosed herein, the radiating elements can be formed from an additively manufactured polymer shell with hollow interior cavities, with the hollow interior cavities (also referred to as “ears”) having a surface shape formed in the same shape as the ears of antenna arrays fabricated via other means. According to one or more examples, a radiating element includes a pair of hollow interior cavities (e.g., a pair of “ears”), with one cavity forming the ground component of the radiating element (e.g., the “ground ear”) and the other cavity forming the signal component of the radiating element (e.g., the “signal ear”). The ground ear of the radiating element can be terminated to the ground of a coaxial connector used for connecting a feed line or directly to a baseplate of the array. The signal ear of the radiating element can be connected to the center of a coaxial feed line such that the signal ear is the active line of the radiating element.

The surface of the signal ear and the ground ear of each radiating element can be metallized via an electroplating process, thus creating electrically isolated radiators with strong inter-element capacitive coupling. Once the surface of each ear is metallized, the unit cell can be assembled by mating the ground plane to the bottom surface of the shell and mating the superstrate to the top surface of the shell. The ground plane can include a plurality of grid lock holes that provide a location for a connector to connect to the signal ears of the radiating elements of the shell. For example, terminal-mount SMA connectors can connect to the signal ears of the radiating elements of the shell. The center pins of the SMA connectors can friction fit to the metallized cavities of the signal ears of each unit cell, which removes reliance on potentially expensive interconnect elements or soldering. Other connector types are possible, as will be discussed below. The ground plane can also include a number of protrusions that can be connected to the ground ears of each unit cell.

The signal and ground ears of each radiating element can be separated from one another by a gap. In apertures manufactured via other methods, the gap can be a void with no material, which can complicate impedance matching properties. In the apertures manufactured as disclosed herein, this gap can be spanned by the dielectric shell that forms the structure of the unit cell. Thus, the unit cell can include a dielectric surface between the signal and ground ears of each radiating element, which increases the capacitance, thereby improving the impedance match from the coaxial transition (via the signal ear) to the superstrate at lower frequencies. The signal and ground ears can also include a tapered shape, which can provide strong impedance matching between the feed port and different scanning directions.

The radiating elements of each unit cell can be arranged orthogonally relative to one another, with a first radiating element (i.e., a first signal ear and ground ear) arranged in a first plane that is orthogonal to the plane that the second radiating element occupies. The signal ear of each radiating element can be located proximate to one another, separated by a gap. Whereas a unit cell manufactured via other means can rely on either air or a plastic insert in this gap, such configurations exhibit decreased inter-element capacitance, which can inhibit low frequency performance. In the unit cells disclosed herein, however, the gap between the signal ears of the radiating elements can be spanned by the dielectric shell that forms the structure of the unit cell. Accordingly, the unit cell can incorporate a dielectric surface between the adjacent radiating elements of the array without requiring adding an additional component when assembling the phased array antenna, providing strong capacitive coupling and improving the performance of the array.

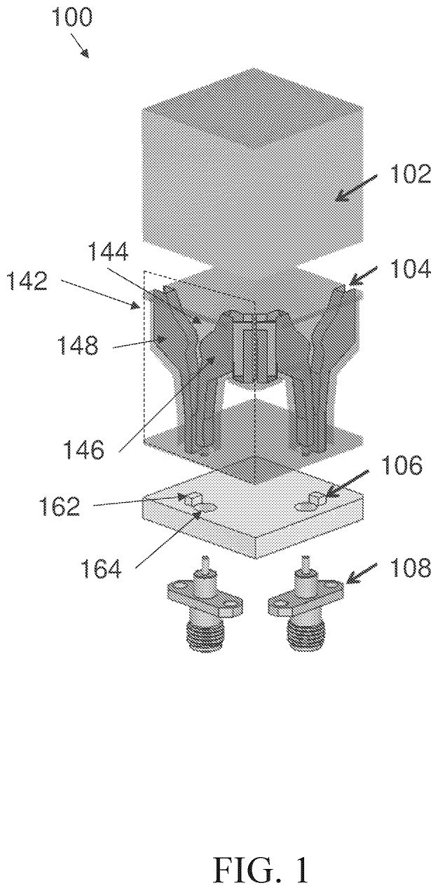

FIG. 1 illustrates an exploded view of a unit cell 100 for a phased array antenna. As illustrated in FIG. 1, a unit cell 100 (which can be repeated throughout a phased array as will be described below) can include a superstrate 102, a shell 104, a base plate 106, and a plurality of connectors 108.

In one or more examples, the superstrate 102 can be formed from a low dielectric loss material that improves the bandwidth of the unit cell 100 when scanning. In one or more examples, the superstrate 102 can be formed from a low dielectric loss material that has a high or low dielectric constant. The superstrate 102 can be used to adjust various impedances associated with the antenna comprising a number of unit cells such as unit cell 100 so as to minimize performance losses associated with VSWR. In one or more examples, the superstrate 102 can include a number of perforations in the superstrate to improve scanning performance when scanning in the diagonal plane (D-plane). In one or more examples, the superstrate 102 can be formed from PTFE having a dielectric constant of εᵣ=2.2. In one or more examples, the superstrate 102 can be fixed to the top surface of the shell 104. For example, the superstrate 102 may be glued to the top surface of the shell 104. Optionally, the superstrate 102 can be one large superstrate that covers each cell in an array, rather than an individual superstrate 102 on top of each individual unit cell 100. In one or more examples, the superstrate 102 can include a number of perforations (e.g., holes), which can improve performance of the phased array antenna.

In one or more examples, the shell 104 can be formed via additively manufacturing a number of metallic pillar-shaped radiators that extend upwards from the base plate 106 in one continuous block. Alternatively, the shell 104 can be printed in a shape that is the inverse of the pillar-shaped radiating elements, e.g., as a continuous shell comprising a number of hollow cavities with an inner surface that matches the same profile of a radiating element fabricated in other manners.

As shown in FIG. 1, the shell 104 can include spectrum element cavities (e.g., radiating elements), such as the radiating element 142 shown within the dashed box. The radiating element 142 can include a signal ear 146 and a ground ear 148 separated by a cavity 144. In one or more examples, and as will be described below, the internal surface of the radiating elements 142 can be metallized such that each radiating element 142 can act as a radiator. Whereas a radiator that is additively manufactured or fabricated by another means such as CNC milling, etc., may be formed in the shape of the cavity 144, the shell 104 is configured such that the shell 104 defines the cavity 144 as the space between the signal ear 146 and the ground ear 148. Accordingly, the shell 104 includes spectrum element cavities (such as the radiating element 142 with the cavity 144) that are formed in a shape that is inverse to how a radiator may be shaped when fabricated via other means.

In one or more examples, metallizing the surface of the radiating element 142 can refer to depositing a metal coating on an inner surface of each of the signal ear 146 and ground ear 148 of the radiating element 142. In one or more examples, metallizing a radiating element 142 rather than forming a radiating element entirely from metal, such as via additively manufacturing the element using metal, can realize significant weight and cost savings. Moreover, by relying on a single continuous piece as the structural component (e.g., as the shell 104) to create the radiating elements 142 of the unit cell, the radiating elements 142 can be mechanically robust and both quicker and easier to assemble. Accordingly, a unit cell configured as shown in FIG. 1 can realize weight, cost, and time savings relative to unit cells that do not incorporate an internally metallized shell such as the shell 104.

In one or more examples, the shell 104 can be a single continuous piece formed via additive manufacturing. Additive manufacturing can involve building (or “printing”) a 3D object incrementally by adding layer-upon-layer of material. Accordingly, building the shell 104 can involve building the shell 104 by adding layer-upon-layer of material to form one continuous object. In one or more examples, the shell can be printed via stereolithography using a polymeric material. Optionally, the shell can be formed from a plastic such as Acrylonitrile butadiene styrene (ABS), Nylon, Polyamides (PA), Polybutylene terephthalate (PBT), Polycarbonates (PC), Polyetheretherketon (PEEK), Polyetherketone (PEK), Polyethylene terephthalate (PET), Polyimides, Polyoxymethylene plastic (POM/Acetal), Polyphenylene sulfide (PPS), Polyphenylene oxide (PPO), Polysulphone (PSU), Polytetrafluoroethylene (PTFE/Teflon), or Ultra-high-molecular-weight polyethylene (UHMWPE/UHMW). According to one or more examples, the shell 104 can be formed from a dielectric material.

In one or more examples, the base plate 106 can be formed from a conductive metal. For example, the base plate 106 can be formed from aluminum, copper, gold, silver, beryllium copper, brass, and/or various steel alloys. Optionally, the base plate 106 can be formed from aluminum that is fabricated via computer numerical control (CNC) machining. According to one or more examples, the base plate 106 can be formed from non-conductive material such as various plastics, including ABS, Nylon, PA, PBT, PC, PEEK, PEK, PET, Polyimides, POM, PPS, PPO, PSU, PTFE, or UHMWPE that is plated or coated with a conductive material such as aluminum, gold, silver, copper, or nickel. Optionally, the base plate 106 can include cutouts (not shown) to reduce the weight of the base plate 106.

In one or more examples, the base plate 106 can be designed to be modular. For example, a number of identical base plates 106 can be fabricated to include mating features along a perimeter of the base plates 106 such that each base plate 106 (i.e., each module) can be connected to adjacent base plates 106 to form a grid. The mating features of each individual base plate 106 can provide both structural rigidity and cross-interface conductivity. Each module (i.e., each base plate 106) may be various sizes incorporating various numbers of unit cells of radiating elements. Optionally, a module is a single unit cell. Alternatively, modules are several unit cells (e.g., 2×2, 4×4), dozens of unit cells (e.g., 5×5, 6×8), hundreds of unit cells (e.g., 10×10, 20×20), thousands of unit cells (e.g., 50×50, 100×100), tens of thousands of unit cells (e.g., 200×200, 400×400), or more. In one or more examples, a module is rectangular rather than square (i.e., more cells along one axis than along the other).

Modules can align along the centerline of a radiating element 142 such that a first module ends with a ground ear of the radiating element (i.e., the ground ear 148) of the shell 104 and the next module begins with another ground ear. Optionally, modules can align such that a first module ends with a signal ear (i.e., the signal ear 146) of the shell 104 and the next module begins with another signal ear. The base plate 106 of a first module may include partial cutouts along its edge to mate with partial cutouts along the edge of the next module to form a receptacle to receive radiating elements that fit between the ground ear along the edges of the two modules. Optionally, the base plate of a module can extend further past the last set of ground ears along one edge than it does along the opposite edge in order to incorporate a last set of receptacles used to receive the set of radiating elements that form the transition between one module and the next. In these examples, the receptacles along the perimeter of the array remain empty. In one or more examples, a transition strip can be used to join modules, with the transition strip incorporating a receptacle for the transition radiating elements. According to certain embodiments, no radiating elements bridge the transition from one module to the next. Arrays formed of modules according to certain embodiments can include various numbers of modules, such as two, four, eight, ten, fifteen, twenty, fifty, a hundred, or more.

In one or more examples, the base plate 106 can be manufactured in various ways such as by machining, casting, or molds. Additionally, the base plate 106 can include holes (such as the holes 164) or cut-outs created by milling, drilling, formed by wire EDM, or formed into the cast or mold used to create the base plate 106. In one or more examples, the base plate 106 can provide structural support for the shell 104 and provide the overall structural support for a phased array antenna comprising a number of cells. The thickness of the base plate may vary depending on the design requirements of a particular application. For example, an array or module with a shell comprising thousands of radiating elements may include a base plate that is thicker than the base plate for an array or module with a few hundred elements in order to provide adequate structural rigidity for the larger dimensioned array. In one or more examples, the base plate is less than 6 inches thick. Optionally, the base plate is less than 3 inches thick, less than 1 inch thick, less than 0.5 inches thick, less than 0.25 inches thick, or less than 0.1 inches thick. In one or more examples, the base plate is between 0.2 and 0.3 inches thick. The thickness of the base plate may be scaled with frequency (e.g., as a function of the wavelength of the highest designed frequency, λ). For example, the thickness of the base plate may be less than 1.0λ, 0.5λ, or less than 0.25λ, Optionally, the thickness of the base plate is greater than 0.1λ, greater than 0.25λ, greater than 0.5λ, or greater than 1.0λ.

The base plate 106 can provide a path to ground and can be electrically connected to one or more of the radiating elements 142 of the shell 104. The base plate 106 can include a number of mating protrusions 162 for coupling to a ground ear of the radiating elements. As shown in FIG. 1, the ground ear 148 of the radiating element 142 is arranged such that it can be coupled to the mating protrusion 162 and thus act as the ground component of the radiating element 142. The base plate 106 can include a number of holes 164 such that a signal ear of the radiating elements can engage a connector 108. As shown in FIG. 1, the signal ear 146 of the radiating element 142 is arranged such that it can be coupled to a connector 108 via the hole 164 of the base plate 106, and thus act as the active component of the radiating element 142. In one or more examples, the connectors 108 can be friction fitted (i.e., interference fitted) into the metalized cavities of the positive ears of the shell 104. In this manner, the connectors 108 can connect to the radiating elements of the unit cell without requiring expensive interconnect elements or soldering. Optionally, the connector 108 can be a coaxial SMA connector.

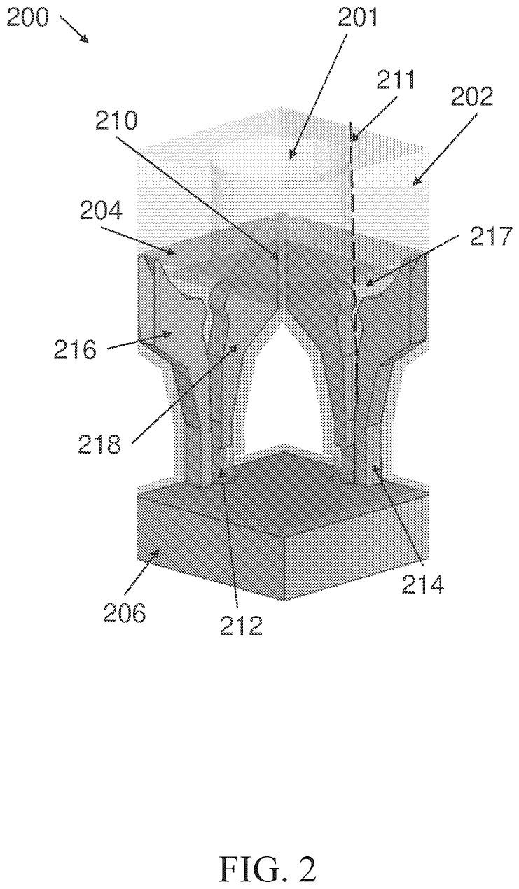

The manner in which the base plate 106 and the shell 104 can be arranged when they are connected to one another is shown more clearly in FIG. 2, which illustrates a perspective view of a unit cell 200 for a phased array antenna, according to one or more examples of the present disclosure. The cell 200 includes a shell 204 with a superstrate 202 on a top surface of the shell 204 and a base plate 206 on the bottom surface of the shell 204. Each of the shell 204, the superstrate 202, and the base plate 206 can be configured as discussed above. The cell 200 can also be configured to connect to a connector, such as the connector discussed above.

The shell 204 includes a pair of radiating elements with each radiating element including a signal ear 218 and a ground ear 216 separated by a shell portion 217. As shown in FIG. 2, each radiating element (i.e., signal ear 218 and ground ear 216) of the shell 204 can be disposed along an axis that is orthogonal to one another, making each radiating element of the pair of radiating elements of the shell 204 arranged orthogonally relative to one another. This orthogonal orientation results in the cell 200 being able to generate orthogonally directed electric field polarizations. A signal beam can be generated by exciting the radiating elements of the cell 200. For instance, a signal beam can be generated via a voltage differential between the signal ear 218 and the ground ear 216 of each radiating element. The generated signal beam of the radiating element shown on the right in FIG. 2 can include a component that is in the direction along centerline 211, which can be centrally located between the signal ear 218 and the ground ear 216 of the rightmost radiating element and perpendicular to the base plate 206. The signal beam generated by the left radiating element can similarly have a direction along the phase center (i.e., centrally located relative to the signal ear 218 and ground ear 216 of the left radiating element) and perpendicular to the base plate 206. As shown in FIG. 2, the phase center of the left and right radiating elements are not co-located relative to one another.

As illustrated in FIG. 2, in one or more examples, each ground ear 216 can include a post 214 that can be connected to the base plate 206, and each signal ear 218 can have a post that terminates above the base plate 206 (without physically coming into contact with the base plate 206). In one or more examples, a void 212 can be created on the lower end of the post of each signal ear 218. This void 212 can be used to attach a connector, such as the connectors discussed above, to each signal ear 218 of the cell 200, as will be discussed below.

In one or more examples, the signal ears 218 of the cell 200 can be arranged proximate to one another, separated by a gap 210. In one or more examples, the gap 210 between the signal ears 218 of the cell 200 can be coaxially aligned with an internal cavity 201 of the superstrate 202. In one or more examples, the shell 204 can occupy the space in the gap 210. In one or more examples, the gap 210 can create interdigitated capacitive coupling between the adjacent signal ears 218. This capacitance can be used to improve the impedance matching of the antenna array including a number of cells 200. As discussed above, the shell can be formed from a dielectric material. Thus, the cell 200 can include a dielectric material that spans the gap 210 between the signal ears 218 of each radiating element. The inclusion of the dielectric material in the gap 210 can improve the capacitive coupling between each radiating element in the cell 200, which can improve the performance of the cell 200 at lower frequencies. Thus, including a dielectric shell that spans the gap 210 between the radiating elements can improve the performance of the cell 200.

In one or more examples, a unit cell manufactured via additively manufacturing the radiating elements can include a support leg that connects the signal ear 218 to the base plate 206 to provide support for the signal ear of the cell. However, including a support leg can degrade performance of the cell at low frequencies. As shown in FIG. 2, each radiating element connects to the base plate 206 via a single connection at the post 214 of each ground ear 216. Thus, the cell 200 is configured without any additional support legs. Accordingly, the cell 200 can exhibit improved performance relative to designs that incorporate a support leg, which can be evidenced by improved performance at lower frequencies.

As discussed above, the shell 204 can be fabricated as a single continuous component via an additive manufacturing process. Manufacturing the shell 204 as a single component can ensure the radiating elements are mechanically robust. Thus, although each radiating element connects to the base plate 206 only via the post 214 of each ground ear 216, there is no need for additional support posts. Removing the need for additional support posts lessens the complexity of fabricating the unit cell 200, which both saves time and reduces the cost to fabricate individual unit cells and an antenna array.

To function as a radiating element with a signal ear and a ground ear, the radiating elements of the shell 204 can generally incorporate a metallic material. One method of incorporating metallic material is to print the radiating element entirely from metal, such as via additively manufacturing the radiating element using metal. However, fabricating the radiating elements entirely from metal increases both the weight and cost of the antenna array. Rather than relying on entirely fabricating the radiating elements from metal, the shell 204 can incorporate metal by metallizing the internal surfaces of the signal ear 218 and the ground ear 216 of each radiating element by including a through-channel to facilitate adding a metallic coating.

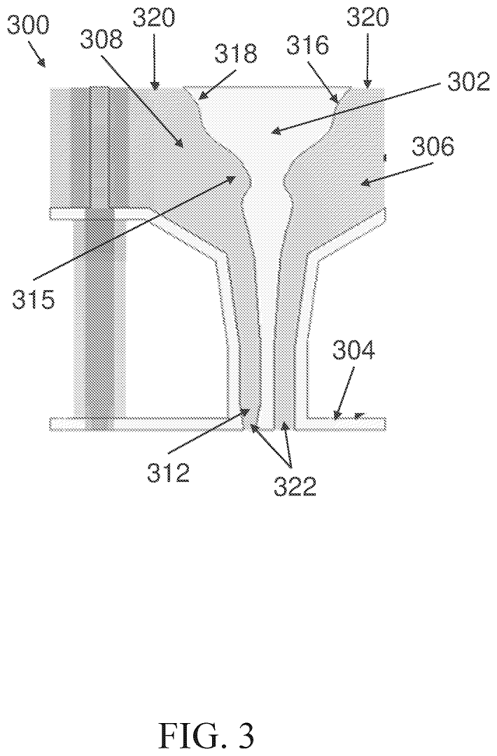

Exemplary through-channels are visible in FIG. 3, which illustrates a side view of an internally metallized antenna array shell 300, according to one or more examples of the present disclosure. The shell 300 can be incorporated into unit cell 100 discussed above. The shell 300 includes a pair of radiating elements arranged orthogonally relative to one another. As shown in FIG. 3, one radiating element is visible, while the other extends orthogonally, as discussed above. The radiating element is formed from the shape of the shell body 304. The shell body 304 can include a number of internal cavities (through-channels) that extend from a top opening 320 to a bottom opening 322, thereby forming radiator-shaped through-channels, e.g. radiator-shaped signal ears (such as signal ear 308 and ground ear 306), that extend through the shell 300.

As shown in FIG. 3, the shell 300 includes a signal ear 308 and a ground ear 306, which can radiate energy received from a connector out into open space. As indicated by the darker shading on the ground ear 306 and signal ear 308 relative to the shell body 304, the inner surface of the ears, such as the inner surface 318 of the signal ear 308 and the inner surface 316 of the ground ear 306 of the radiating element can be coated with a conductive material. For instance, the ground ear 306 and signal ear 308 can be coated with a metallic material such as copper, aluminum, gold, silver, beryllium copper, and/or brass. In one or more examples, the metallic coating can be 0.005 inches thick, 0.004 inches thick, 0.003 inches thick, 0.002 inches thick, or 0.001 inches thick. Optionally, the metallic coating may be more than 0.005 inches thick.

In one or more examples, the internally metallized cavities can be used to radiate energy received from a coaxial cable connected to the signal ear 308 out into free space. In one or more examples, the shell 300 can be connected to a base plate and a connector as discussed above, with the connector attached to the post 312 of the signal ear 308. Optionally, the post 312 of the signal ear 308 can be tapered, as shown in FIG. 3, such that when a connector is attached to the post 312, the attachment is secure and does not shear away any of the metal coating on the surface of the post 312.

As shown in FIG. 3, in one or more examples, the shell body 304 can surround the radiating elements (i.e., each signal ear 308 and ground ear 306) and occupy the space between the signal ear 308 and the ground ear 306, such as via the shell portion 302. In one or more examples, in a unit cell for an aperture array that does not include an additively manufactured shell like the shell 300, the shell portion 302 between the ground and signal ear of each radiating element is instead an air-filled gap. As shown in FIG. 3, however the shell portion 302 of the shell body 304 fills that space. As discussed above, the shell 300 can be formed from a dielectric material. Thus, in one or more examples, the shell portion 302 between the ears (the signal ear 308 and the ground ear 306) of each radiating element can be filled by a dielectric surface. Including a dielectric surface in this gap can reduce the number of reflections caused by the radiating elements, which improves the performance of the antenna unit. For instance, in a unit cell without dielectric between the signal ear 308 and the ground ear 306, energy received by the signal ear 308 will experience a first media change at the connection between the connector and the signal ear 308, and experience an additional media change when the energy radiated via the signal ear 308 reaches the air-filled gap. Including a dielectric in the shell portion 302, however, can reduce the reflections the energy experiences, thereby improving the performance of the radiating element.

As shown, the inner surfaces of the signal ear 308 and the ground ear 306 can be tapered, with a bump 315 on each ear extending towards one another. In one or more examples, the taper of the signal ears can impact the impedance of the radiating elements. The taper and/or the bump 315 can be used to balance the scan performance of the radiating elements. For instance, in a shell configured without a bump 315, scanning in one direction may reach up to 7 GHz, whereas scanning in another direction (with a different impedance) reaches only 5 GHz. By including a bump 315, however these values can be normalized, resulting with a uniform scanning to 6 GHz across different scan angles. Thus, in one or more examples, the taper and/or the bump 315 of the ears of each radiating element can minimize the energy being reflected due to differences in impedance. In one or more examples, the taper/bump 315 can be included to impedance match the ears of each radiating element, thus minimizing the VSWR and improving the quality of the impedance match and the performance of the antenna element.

In one or more examples, the connection of the post 312 to the connector can be formed as an unbalanced twin lead transmission line. The impedance of the transmission line can increase based on the spacing between the transmission lines (because of the tapered shape of the signal ear 308 and the ground ear 306. For example, at the base of the post 312, the impedance of the transmission line can be 50 Ohms, at the transition to free space without a dielectric surface, this impedance can increase to 377 Ohms. Thus, by including a dielectric material at the transition point with a lower impedance than the impedance of transition to free space, the transition is gentler, causing fewer reflections. In one or more examples, the impedance of free space can differ depending on the beam forming and scanning being performed by the unit cell and/or phased array.

The engagement between the signal ear 308 of a given radiating element of the shell 300 and a connector can provide an electrical path for the radiating element. One type of engagement between the signal ear 308 and an electrical connector can rely on soldering the electrical connector directly to the signal ear 308. When relying on a material such as a polymer for the shell 300, however, soldering an electrical connector directly to the signal ear 308 may be hampered by the possibility of melting the signal ear 308 via the heat required to solder. Accordingly, alternative engagement configurations may be necessary.

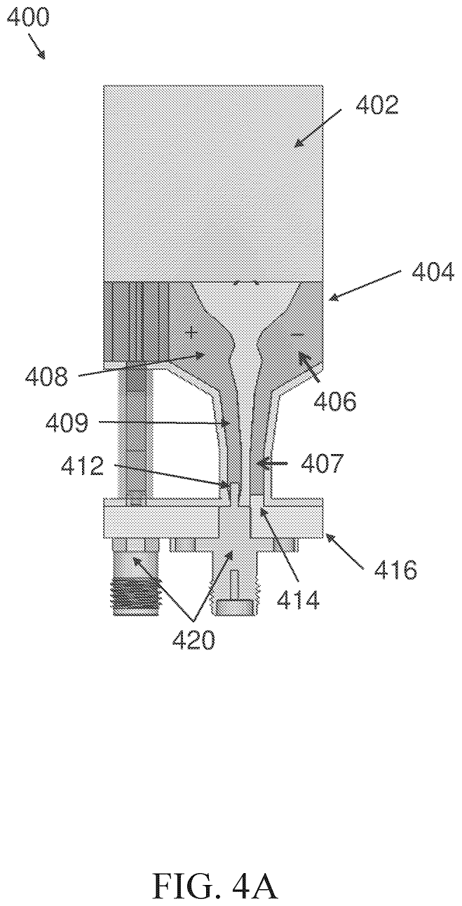

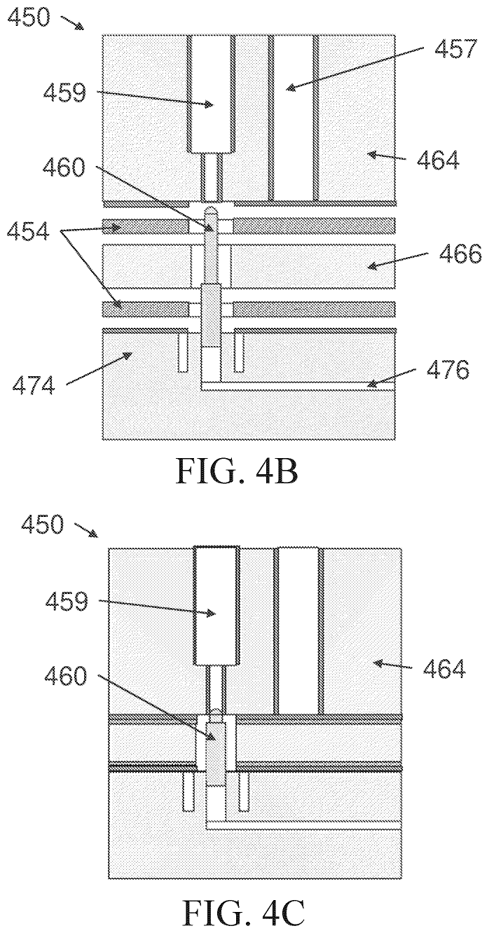

An exemplary engagement between a signal ear and ground ear of a shell and a connector is shown in FIG. 4A, which illustrates a side view of a unit cell 400 for a phased array antenna, according to one or more examples of the present disclosure. The unit cell 400 can be configured as the unit cells discussed above. The unit cell 400 includes a superstrate 402 on a top surface of a shell 404 comprising radiating elements, with a base plate 416 and connector 420 on the bottom surface of the shell 404.

As shown in FIG. 4A, each radiating element of the shell 404 includes a signal ear 408 with a post 409 connected to the upper portion 412 of the connector 420. The connection between the signal ear 408 and the connector 420 can provide an electrically isolated path, wherein the signal ear 408 is electrical isolated (insulated) from the base plate 416 and the ground ear 406. The ground ear 406 can be connected to the protrusion 414 of the base plate 416. Optionally, the base plate comprises a number of protrusions 414 that can be connected to corresponding ground ears of the shell 404. In one or more examples, the post 407 of each ground ear 406 of the shell 404 is friction fit to a protrusion 414 of the base plate 416.

Another exemplary engagement between a signal ear and a ground ear of a shell and a connector is shown in FIGS. 4B and 4C, which illustrate a detail view of the connector region of a unit cell 450 for a phased array antenna in an exploded view and assembled view, respectively. The unit cell 450 can be configured as the unit cells discussed above. As shown in FIG. 4B, the unit cell 450 includes a shell 464 that has a signal ear that terminates with a post 459 and a ground ear that terminates a post 457. Unlike the example shown in FIG. 4A, the base plate 466 does not include protrusions. Instead, the unit cell 450 includes a compressible metal surface 454 between the shell 464 and the base plate 466. When assembled, as shown in FIG. 4C, the compressible metal surface 454 compresses between the shell 464 and the base plate 466, forming a uniform electrical fit between the post 457 of the shell 464, which can be metallized along its inner surface as described above.

As shown clearly in FIG. 4B, the compressible metal surface 454 includes a cutout in the area where a connector 460 extends to meet the post 459 of the signal ear of the shell 464. Accordingly, the connection between the connector 460 and the post 459 of the signal ear is electrically isolated from the base plate 466 and the post 457 of the ground ear of the shell 464. Optionally, the compressible metal surface 454 can be a metal foam, such as foamed copper or nickel. In one or more examples, the metal surface 454 can be a rubberized foam that includes a conductive material.

The connector 460 can be a spring-loaded member that can be compressed when the unit cell is assembled, as shown in FIG. 4C. In the assembled state, the connector 460 contacts the post 459 of the signal ear of the shell 464. In one or more examples, the spring-loaded connector 460 ensures the contact between the connector 460 and the post 459 of the signal ear of the shell 464 remains uniform so long as the unit cell 450 is assembled. In one or more examples, the connector 460 is a pogo pin. In one or more examples, the thickness of the base plate 466 can be scaled with the compressed length of the connector 460, such that the base plate 466 provides the appropriate spacing between the shell 464 the connector 460.

The connector 460 extends between the post 459 of the shell 464 to a printed circuit board (PCB) feed network 474. Accordingly, the unit cell 450 differs from the unit cells discussed above in that each individual unit cell does not connect to an independent connector. Rather, the unit cell 450 connects to a PCB feed network 474. When incorporated into an array, as will be discussed below, a number of unit cells 450 can be connected to a single PCB feed network 474, thereby reducing the number of elements of the phased array antenna. In the assembled configuration, the connector 460 can act as the center pin of a coaxial waveguide, with the base plate 466 acting as the outer conductor of the coaxial waveguide.

As shown, the PCB feed network 474 can include PCB traces 476, which conduct signals along the PCB feed network 474. The PCB traces 476 can be formed from a conductive material such as copper, aluminum, nickel, etc. The PCB traces 476 can be embedded in the PCB feed network 474, or they may be located on a surface of the PCB feed network 474. The connector 460 can be connected to the PCB network 474 such that the connector 460 contacts the PCB traces 476. For instance, the connector 460 can be soldered directly to the PCB traces 476.

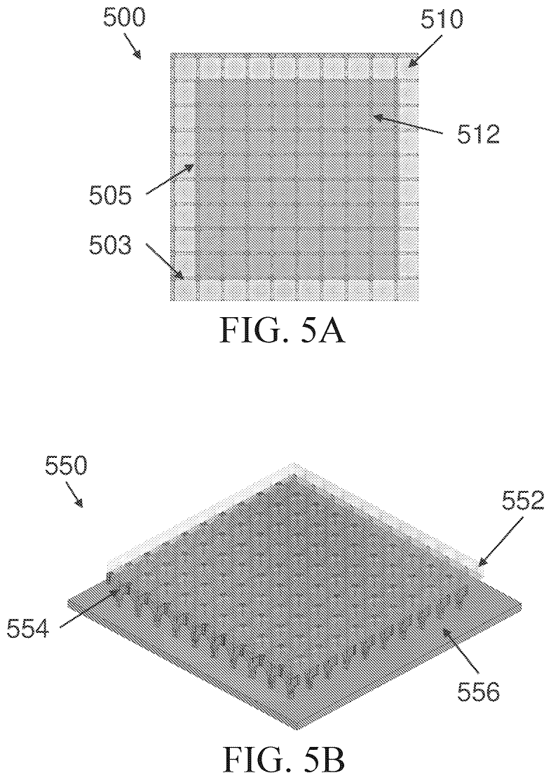

As mentioned above, a phased array can include a plurality of unit cells arranged together. FIG. 5A illustrates a plan view of a phased array 500, according to one or more examples of the present disclosure. The array 500 can include a number of unit cells as discussed above repeated and arranged in the array 500. That is, the array 500 can include a number of unit cells configured as the unit cell 100 of FIG. 1 with a base plate that provides a path to ground for a ground ear of the radiating elements of the unit cell 100, a shell that includes a number of radiating elements (e.g., the spectrum element cavities) with a metallic coating on an inner surface of the radiating elements and including a signal ear with a post that is aligned with a hole of the based plate and engaged with a connector via the hole, and a ground ear with a post that is engaged with a mating protrusion of the base plate. The array 500 can be implemented as a dual polarized array, including multiple columns of vertical radiating elements 505 oriented along a first polarization axis (referred to herein as vertically polarized) and multiple rows of horizontal radiating elements 503 oriented along a second polarization axis (referred to herein as horizontally polarized). The radiating elements 505 and 503 can be configured as described above to be formed from internally metallized spectrum cavity structures that are formed from a shell and each unit cell of the array can be arranged and manufactured according to the examples described above with respect to FIGS. 1-4 described above.

In one or more examples, the radiating elements 505 and 503 can be formed from a single shell that extends along the entire array. Optionally, the array 500 may include only single polarized radiating elements (e.g., only rows or only columns of radiating elements). The array 500 can include varied spacing among sets of radiating elements (e.g., the horizontally polarized radiating elements 503 may be spaced apart from one another in a different amount than the spacing between the vertically polarized radiating elements 505). In one more examples, the spacing in a given row or column may not be uniform. For example, the spacing between the first and second horizontal radiating elements 503 in a given row may be different from the spacing between the second and third elements.

The array 500 can incorporate a guard band on the perimeter of the array. As shown in FIG. 5A, the array 500 includes a guard band 510 that surrounds the active elements, illustrated by the shaded box 512. The guard band 510 can include a number of guard band antenna elements (“guard band elements”) that have a matched load to the adjacent active elements (those in the shaded box 512), with the inactive guard band elements serving to mitigate edge effects. Incorporating a guard band such as the guard band 510 beneficially ensures that the excited antenna elements (the active elements in the shaded box 512) always have elements that surround them on each side. The guard band 510 shown in FIG. 5 can be one element wide, resulting with an 8×8 square of active elements. The guard band 510 can optionally be more than one element wide.

FIG. 5B illustrates a perspective view of a phased array 550, according to one or more examples of the present disclosure. As shown, the array 550 includes a shell 554 located between a base plate 556 and a superstrate 552, which can be configured as described above. The superstrate 552 may be connected to the shell 554 via one or more standoffs or spacers, such as by Nylon spacers (not shown). Optionally, the superstrate 552 can extend past the edges of the shell 554. Although a 10×10 array 550 is shown in FIG. 5B, this should not be construed as limiting, as any number of cells can be incorporated into the array 550.

As shown in FIG. 5B, the unit cells are arranged in a regular pattern which here corresponds to a square grid array 550. Those of ordinary skill in the art would appreciate that the unit cells need not be disposed in a regular pattern. In one or more examples, it may be necessary or desirable to dispose unit cells in such a manner that the radiating elements of each unit cell are not aligned with the radiating elements of adjacent cells. In such examples, the shell of the array 550 can be fabricated via a single continuous piece that does not exhibit a uniform square pattern. Such configurations can include, but are not limited to, a rectangular or triangular lattice of unit cells wherein the individual unit cells are aligned relative to one another or with individual unit cells that are rotated relative to adjacent unit cells within the lattice pattern.

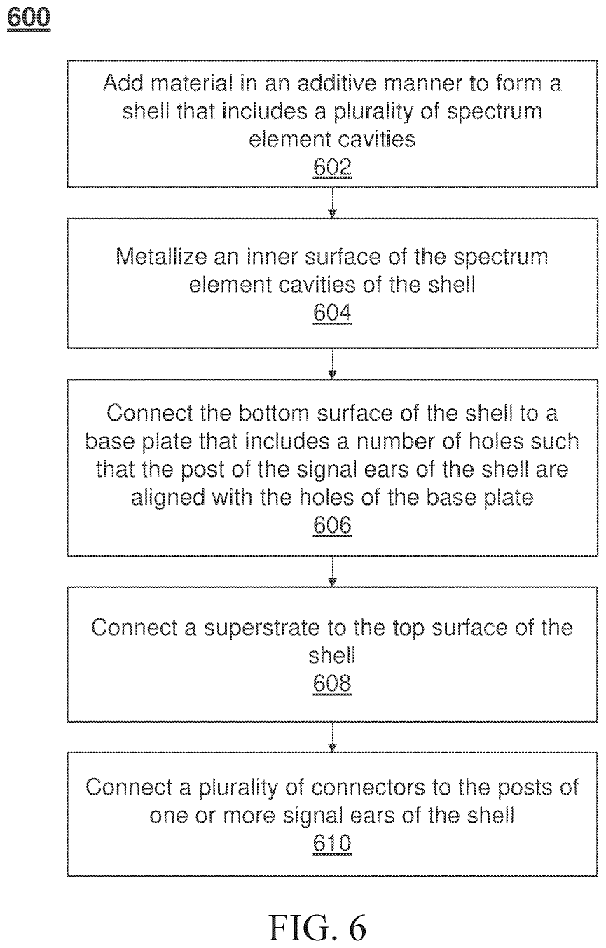

As discussed above, the unit cells for the phased array antenna can be manufactured via CNC milling, or a variety of additive manufacturing processes. FIG. 6 shows an exemplary method 600 for manufacturing a unit cell for a phased array antenna, according to one or more examples of the present disclosure. The method 600 can be used to manufacture the unit cells described above to be incorporated into a phased array such as the arrays discussed above.

In one or more examples, the method 600 can begin at step 602 wherein material is added in an additive manner to form a shell that includes a plurality of spectrum element cavities. Adding material in an additive manner can include relying on VAT polymerization, stereolithography, direct light processing, direct UV printing, LCD VAT polymerization, etc. The shell created via step 602 can include a plurality of spectrum element cavities with an upper opening and a lower opening that form a through-channel, as described above. The shell created at step 602 can be larger than a single unit cell, as discussed above. For instance, the shell created at step 602 can include every spectrum element cavity for an entire array. That is, the shell can include the spectrum element cavities for an array of cells rather than for only a single cell. Fabricating the shell to include the spectrum element cavities for the entire array can reduce post-processing and fabrication steps by removing the necessity to assemble each unit to one another, which can realize cost and time savings to fabricate a phased array antenna. Additionally, fabricating an array shell rather than a number of unit shells can improve the mechanical strength of the radiating elements by incorporating each radiating element into one large structure, rather than a plurality of pillar-shaped elements that may be easily broken. Moreover, by relying on a continuous polymeric shell for the structure of the array, the phased array antenna can eliminate gaps between radiating elements, which provides stronger capacitive coupling and improved performance of the array.

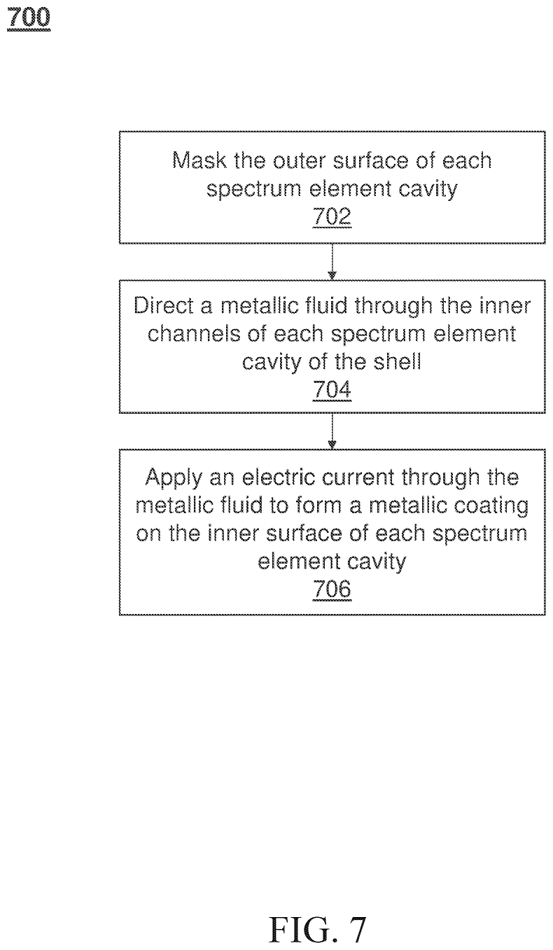

After creating the shell via step 602, the method 600 can move to step 604 wherein the inner surface of the spectrum element cavities of the shell are metallized. In one or more examples, metallizing the inner surfaces of the spectrum element cavities can be performed via electroplating, which can include covering the inner surfaces of the spectrum element cavities with a liquid metallic material and applying an electric current to the liquid material which causes the liquid to form an even metal coating that then solidifies into a metal layer. In one or more examples, the electroplating process performed at step 604 can be customized according to the additive manufacturing method 600 for creating an array element. FIG. 7 shows an exemplary method 700 for internally metallizing a shell for a phased array antenna, according to one or more examples of the present disclosure. The method 700 can begin at step 702 wherein the outer surfaces of each spectrum element cavity of the shell are masked. By masking the outer surfaces of each spectrum element cavity, the method 700 can ensure that only the inner surfaces of the spectrum element cavities are metallized, which can ensure that components of each unit cell can be properly isolated (insulated) from one another if necessary. For instance, by ensuring that only the inner surfaces of the signal ear 408 shown in FIG. 4A are metallized, the signal ear 408 can be electrically isolated from the ground ear 406 and the base plate 416. Electrically isolating the components of the unit cell from one another ensures that a voltage differential can be created between the signal ear 408 and the ground ear 406, which can be used to generate a signal beam, as discussed above.

Returning back to the example method 700 of FIG. 7, after masking the outer surfaces of each spectrum element cavity at step 702, the method 700 can move to step 704, wherein a metallic fluid is directed through the inner channels of each spectrum element cavity of the shell. For instance, as shown in FIG. 3, the shell 300 includes a channel running between the top opening 320 and the bottom opening 322. A metallic fluid can be poured into this channel and allowed to coat all of the inner surfaces of the spectrum element cavities (e.g., of the ground ear 306 and the signal ear 308).

After flowing the metallic fluid through the inner channels at step 704, the method 700 can move to step 706 and wherein an electric current is applied through the metallic fluid to form a metallic coating on the inner surfaces of the spectrum element cavities of the shell. For instance, applying an electric current at step 706 can result with a copper accumulation on the inner surfaces of the spectrum element cavities that once hardened forms a metal coating. Copper is used herein for example only, as the metallic coating can alternatively include other conductive metals such as aluminum, gold, silver, beryllium copper, brass, and/or various steel alloys.

After additively manufacturing the shell as described in step 602 of the method 600 and metallizing the inner surfaces of the spectrum element cavities of the shell, as described in step 604 of the method 600 and more fully in the method 700, this shell can be used in an aperture array, such as the aperture arrays described above.

Returning now to FIG. 6, after metallizing the inner surface of the spectrum element cavities at step 604, the method 600 can move to step 606 wherein a bottom surface of the shell is connected to the base plate of the element. As shown and described above with respect to FIG. 4A, the base plate 416 of the unit cell 400 can include a number of protrusions 414 that facilitate connecting the base plate 416 to the shell 404. Thus, at step 606, connecting the base plate and the shell can involve aligning the post 407 of the ground ears 406 of the shell 404 with the protrusions 414 of the base plate. In one or more examples, the connection between the protrusions and the base plate can be a friction fit relying only on pressing the base plate and the shell together.

After connecting the base plate and the shell at step 606, the method 600 can move to step 608 wherein the superstrate of the array is connected to the top surface of the shell. The superstrate can be connected to the shell by a variety of attachment elements. For instance, the superstrate can connected to the shell via a plurality of standoffs. As discussed above, the superstrate of each individual cell of the array can include an internal cavity that aligns with the gap between adjacent signal ears of the array. Thus, connecting the superstrate to the shell at step 608 can involve aligning the internal cavities of the superstrate with the gaps in the shell.

After connecting the superstrate at step 608, the method 600 can move to step 610 wherein a plurality of connectors are connected to the posts of one or more of the signal ears of the shell. As discussed above with respect to FIG. 4A, the connectors can be connected to the post of the signal ears of the shell such that the signal ears of the shell are electrically isolated from the base plate and the ground ear. For example, the connectors can be coaxial SMA connectors that facilitate connecting a coaxial cable to the signal ears of the shell. Connecting the connector and the signal ears at step 610 can involve a simple friction fit between the post of the signal ears and the connector. Thus, step 610 can be performed without expensive interconnect elements or soldering.

As discussed above, fabricating the apertures of the aperture array by additively manufacturing a shell that includes a number of spectrum element cavities (as described in step 602 of the method 600) shaped in the inverse of radiating elements manufactured by other methods and then metallizing only the inner surfaces of the spectrum element cavities of the shell (as described in step 604 of the method 600) to create the radiating elements of the array can realize significant weight, cost, and material savings. Moreover, a shell created via the method 600 can also be more structurally robust, being one continuous piece rather than a collection of radiating elements, and provide stronger capacitive coupling and improved performance by eliminating gaps between the radiating elements of the array and providing a dielectric material between the signal and ground ears of each radiating element. Finally, by manufacturing the unit cell as described herein, the unit cell also removes the need for post-processing and added elements such as interconnect elements or soldering between different components of the unit cell. Accordingly, a unit cell for a phased array antenna manufactured according to the method 600 can be improved in a variety of manners relative to a unit cell that is not manufactured as disclosed herein by additively manufacturing a shell in an inverted manner to include spectrum element cavities that can be metallized to create radiating elements.

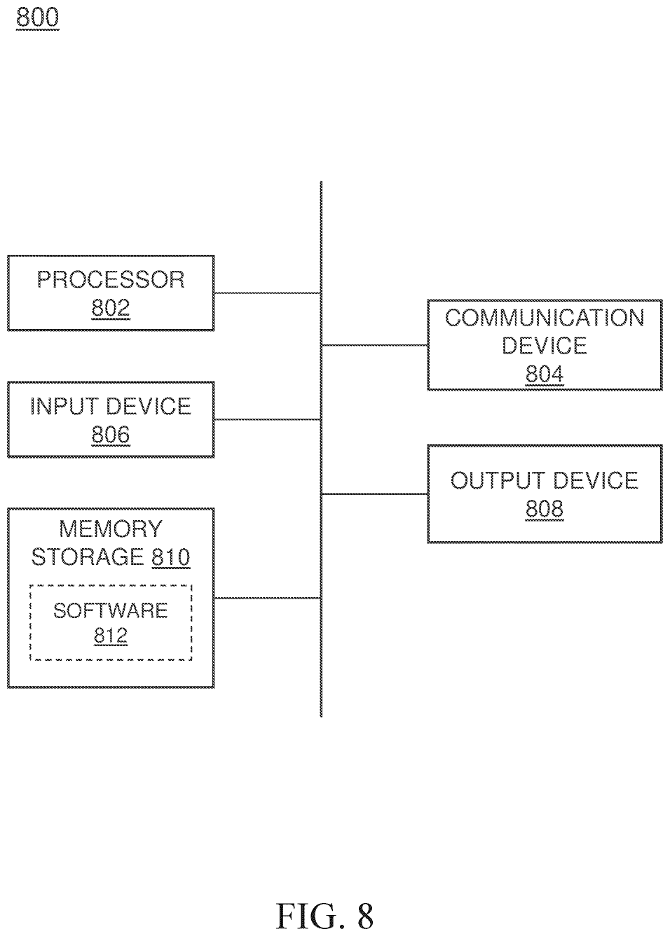

FIG. 8 illustrates an exemplary computing device 800, in accordance with one or more examples of the disclosure. Device 800 can be a host computer connected to a network. Device 800 can be a client computer or a server. As shown in FIG. 8, device 800 can be any suitable type of microprocessor-based device, such as a personal computer, workstation, server, or handheld computing device (portable electronic device) such as a phone or tablet. The device can include, for example, one or more of processors 802, input device 806, output device 808, storage 810, and communication device 804. Input device 806 and output device 808 can generally correspond to those described above and can either be connectable or integrated with the computer.

Input device 806 can be any suitable device that provides input, such as a touch screen, keyboard or keypad, mouse, or voice-recognition device. Output device 808 can be any suitable device that provides output, such as a touch screen, haptics device, or speaker.

Storage 810 can be any suitable device that provides storage, such as an electrical, magnetic, or optical memory, including a RAM, cache, hard drive, or removable storage disk. Communication device 804 can include any suitable device capable of transmitting and receiving signals over a network, such as a network interface chip or device. The components of the computer can be connected in any suitable manner, such as via a physical bus or wirelessly.

Software 812, which can be stored in storage 810 and executed by processor 802, can include, for example, the programming that embodies the functionality of the present disclosure (e.g., as embodied in the devices as described above).

Software 812 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 810, that can contain or store programming for use by or in connection with an instruction execution system, apparatus, or device.

Software 812 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 800 can implement any operating system suitable for operating on the network. Software 812 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

In accordance with the foregoing, internally metallized additively manufactured antenna elements can provide wide bandwidth, wide scan volume, good polarization, and improved inter-element capacitance for improved low frequency performance in a low loss, lightweight and mechanically robust design that is easy and inexpensive to manufacture. The unit cells and manufacturing processes may be scalable and may be combined into an array of any dimension to meet desired antenna performance.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A unit cell for a phased array antenna, the unit cell comprising:
a base plate, wherein the base plate is configured to provide a path to ground, and wherein the base plate comprises a plurality of holes;
a shell that comprises a plurality of spectrum element cavities, wherein an inner surface of each of the spectrum element cavities is coated with a conductive material to form a signal ear and a ground ear that each comprise a post; and
wherein the shell is aligned with the base plate such that the post of the signal ear of each spectrum element cavity is aligned with one of plurality of holes of the base plate.

2. The unit cell of claim 1, wherein the shell is formed using an additive manufacturing process.

3. The unit cell of claim 2, wherein the shell is formed from a dielectric material.

4. The unit cell of claim 2, wherein the additive manufacturing process includes stereolithography.

5. The unit cell of claim 2, wherein the additive manufacturing process includes VAT polymerization.

6. The unit cell of claim 1, wherein the inner surfaces of each spectrum element cavity are coated with a copper layer.

7. The unit cell of claim 6, wherein the copper layer is 0.002 inches thick.

8. The unit cell of claim 1, wherein the base plate comprises a plurality of mating protrusions.

9. The unit cell of claim 8, wherein the shell is aligned with the base plate such that the post of the ground ear of each spectrum element cavity is aligned with one of the plurality of mating protrusions of the base plate.

10. The unit cell of claim 1, wherein the base plate is formed from aluminum.

11. The unit cell of claim 1, wherein two adjacent spectrum element cavities of the plurality of spectrum element cavities are arranged orthogonally relative to one another.

12. The unit cell of claim 11, wherein the signal ear of a first spectrum element cavity is located proximate to the signal ear of an adjacent spectrum element cavity separated by a gap.

13. The unit cell of claim 12, wherein the unit cell comprises a superstrate located on a top surface of the shell, the superstrate comprising an internal cavity that is aligned with the gap between the signal ears of each spectrum element cavity of the shell.

14. The unit cell of claim 13, wherein the superstrate is formed from PTFE.

15. The unit cell of claim 1, wherein an inner surface of each of the signal ears and the ground ears of the spectrum element cavities comprises a taper.

16. The unit cell of claim 1, wherein the post of each of the signal ears is connected to a connector.

17. The unit cell of claim 16, wherein the connection between each signal ear and each connector provides an electrically isolated path.

18. A phased array antenna comprising:
a plurality of unit cells, wherein each unit cell comprises:
a base plate, wherein the base plate is configured to provide a path to ground, and wherein the base plate comprises a plurality of holes;
a shell that comprises a plurality of spectrum element cavities, wherein an inner surface of each of the spectrum element cavities is coated with a conductive material to form a signal ear and a ground ear that each comprise a post; and
wherein the shell is aligned with the base plate such that the post of the signal ear of each spectrum element cavity is aligned with one of plurality of holes of the base plate.

19. The phased array antenna of claim 18, wherein the shell is formed using an additive manufacturing process.

20. The phased array antenna of claim 19, wherein the shell is formed from a dielectric material.

21. The phased array antenna of claim 19, wherein the additive manufacturing process includes stereolithography.

22. The phased array antenna of claim 19, wherein the additive manufacturing process includes VAT polymerization.

23. The phased array antenna of claim 18, wherein the inner surfaces of each spectrum element cavity are coated with a copper layer.

24. The phased array antenna of claim 23, wherein the copper layer is 0.002 inches thick.

25. The phased array antenna of claim 18, wherein the base plate comprises a plurality of mating protrusions.

26. The phased array antenna of claim 25, wherein the shell is aligned with the base plate such that the post of the ground ear of each spectrum element cavity is aligned with one of the plurality of mating protrusions of the base plate.

27. The phased array antenna of claim 18, wherein the base plate is formed from aluminum.

28. The phased array antenna of claim 18, wherein two adjacent spectrum element cavities of the plurality of spectrum element cavities are arranged orthogonally relative to one another.

29. The phased array antenna of claim 28, wherein the signal ear of a first spectrum element cavity is located proximate to the signal ear of an adjacent spectrum element cavity separated by a gap.

30. The phased array antenna of claim 29, wherein the unit cell comprises a superstrate located on a top surface of the shell, the superstrate comprising an internal cavity that is aligned with the gap between the signal ears of each spectrum element cavity of the shell.

31. The phased array antenna of claim 30, wherein the superstrate is formed from PTFE.

32. The phased array antenna of claim 18, wherein an inner surface of each of the signal ears and the ground ears of the spectrum element cavities comprises a taper.

33. The phased array antenna of claim 18, wherein the post of each of the signal ears is connected to a connector.

34. The phased array antenna of claim 33, wherein the connection between each signal ear and each connector provides an electrically isolated path.

35. A method for manufacturing a unit cell for a phased array antenna, the method comprising:
adding a material in an additive manner to form a shell, wherein the shell comprises a plurality of spectrum element cavities;
metallizing an inner surface of each of the spectrum element cavities with a conductive material to form a signal ear and a ground ear that each comprise a post; and
connecting the shell to a base plate that comprises a plurality of holes, wherein the base plate is configured to provide a path to ground;
wherein the shell is aligned with the base plate such that the post of the signal ear of each spectrum element cavity is aligned with one of the plurality of holes of the base plate.

36. The method of claim 35, the material of the shell is a dielectric material.

37. The method of claim 35, wherein adding the material in the additive manner comprises employing a stereolithography process.

38. The method of claim 35, wherein adding the material in the additive manner comprises employing a VAT polymerization process.

39. The method of claim 35, wherein metallizing the inner surface of each spectrum element cavity comprises:
masking an outer surface of each spectrum element cavity to prevent metallization; and
electroplating the inner surface of each spectrum element cavity via an electroplating bath.

40. The method of claim 35, wherein the inner surface of each spectrum element is metallized with a copper layer.

41. The method of claim 40, wherein the copper layer is 0.002 inches thick.

42. The method of claim 35, wherein the base plate comprises a plurality of mating protrusions.

43. The method of claim 35, wherein the shell is aligned with the base plate such that the post of the ground ear of each spectrum element cavity is aligned with one of the plurality of mating protrusions of the base plate.

44. The method of claim 35, wherein the base plate is formed from aluminum.

45. The method of claim 35, wherein two adjacent spectrum element cavities of the plurality of spectrum element cavities are arranged orthogonally relative to one another.

46. The method of claim 45, wherein the signal ear of a first spectrum element is located proximate to the signal ear of an adjacent spectrum element cavity separated by a gap.

47. The method of claim 46, comprising:
connecting a superstrate to a top surface of the shell, the superstrate comprising an internal cavity, wherein the internal cavity of the superstrate is aligned with the gap between the signal ears of each spectrum element cavity of the shell.

48. The method of claim 47, wherein the superstrate is formed from PTFE.

49. The method of claim 35, wherein an inner surface of each of the signal ears and the ground ears of the spectrum element cavities comprises a taper.

50. The method of claim 35, wherein the post of each of the signal ears is connected to a connector.

51. The method of claim 50, wherein the connection between each signal ear and each connector provides an electrically isolated path.
